(19) United States
(12) Patent Application Publication
(10) Pub. No.: US 2005/0040101 A1
(43) Pub. Date: Feb. 24, 2005

(54) Hollow fiber membrane for the treatment of waste lubricants and method for its production

(76) Inventors: Jianfeng Kong, Singapore (SG); Yutie Liu, London (GB); Fook Sin Wong, Singapore (SG)

Correspondence Address: George D Liu;Lawrence Y D Ho & Associates, 2101 Crystal Plaza Arc, PMB 400, Arlington, VA, 22202, US

(21) Appl. No.: 10/486,901

(22) PCT Filed: Aug. 8, 2002
(86) PCT No.: PCT/SG02/00181

(30) Foreign Application Priority Data
Aug. 17, 2001 (SG) 200104980-8

(51) Int. Cl. B01D 69/08

(52) U.S. Cl. 210/500.23; 264/41

(57) ABSTRACT

The present invention proposes a new formulation for the making of a cellulose acetate hollow fiber membrane for ultrafiltration with high water permeability, capable of oil and water separation with minimal energy consumption and low fouling tendencies.

### FIELD OF THE INVENTION

The present invention relates to the purification of water contaminated with oily lubricants using cellulose acetate hollow fiber membranes.

### BACKGROUND OF THE INVENTION

Lubricant fluids are widely used in machining processes like metal finishing, metal working and also in the electronics industries. They are used for a variety of reasons such as improving equipment life, reducing work piece thermal deformation, improving surface finish and flushing away impurities from the work zone.

There are various categories of such lubricants and one of the most popular is the soluble oil fluids. The oil concentrate of such oil fluids consists of mineral oils and some emulsifiers. They are used in a diluted form with water having an oil concentration of about 3-10%. Together they form a stable emulsion when mixed with water. The resulting oil-in-water emulsion typically has a milky white appearance. After extended periods of use, the emulsion usually becomes inefficient through progressive degradation or contamination and requires replacement. The waste lubricant fluid has to be treated to local environmental sewage standards before it can be disposed of properly. Current practices of waste lubrication fluid treatment involves essentially two steps: 1) Solid-liquid separation and then 2) Liquid-liquid separation.

Solid-liquid separation is to remove solid contaminants like work piece debris from the waste fluid before going to the second step. Current methods basically involve some form of filtration or centrifugal action to separate the solid contaminants from the liquids. Solid contaminants can also be separated by allowing the solids to settle to the bottom of a container.

Liquid-liquid separation is more complex. The oil-in-water emulsion has to be broken into its separate oil and water components before disposal. This is often done using chemicals to break the emulsion. However, this method results in more chemicals being present in the water. The oil layer is then skimmed off to separate the oil from the water. The water has to be further treated before discarding while the recovered oil is often reused as fuels or simply incinerated. Another method used is to subject the liquid to centrifugal action to separate the oil from water.

As can be seen, the treatment of such oil-in-water emulsions from waste lubricants is not a simple matter. The equipment, space and costs involved are generally quite high. Merely separating the oil from the water is not enough. The water must meet the environmental standards of local authorities before it can be discharged. Most current methods do not provide a simple solution to separating the oil from the water and treating the water at the same time. In addition, some of the oil droplets formed in such emulsions are so fine that they cannot be easily separated by the above mentioned conventional methods.

A known proposed alternative is the use of ultrafiltration membranes to separate the oil from the water in such emulsions. This method also has the distinct advantage of reducing Chemical Oxygen Demand (COD) levels which is a criteria in waste water disposal. However, present use of commercially available tubular or hollow fiber membranes for the treatment of such waste lubricant fluids causes serious fouling problems due to the hydrophobic characteristics of the membranes. Furthermore, the equipment is expensive and consumes large amounts of energy. The life of the membranes could be greatly affected due to the serious fouling problem associated with currently available membranes.

The present invention proposes a new formulation for the making of a cellulose acetate hollow fiber membrane with high water permeability, capable of oil and water separation with low fouling tendencies.

### OBJECTIVE OF THE PRESENT INVENTION

To provide a new cellulose acetate ultrafiltration hollow fiber membrane capable of separating oils from waste lubricant fluids with the following characteristics: low fouling by oil, high water permeability and high COD and oil removal. To provide a method of producing such a membrane that has all the above listed characteristics.

### SUMMARY OF THE INVENTION

The objectives of the invention are achieved by producing a hollow fiber membrane from cellulose acetate. The characteristics of the membrane are: a molecular weight cut-off (MWCO) of 5,000 to 30,000, a pure water permeability of 100 to 300 L/m².h.bar and a low fouling tendency by the retentate(oil). The method of manufacture of the hollow fibers has also been made simpler to reduce costs and simplify production.

### BRIEF DESCRIPTION OF THE DRAWINGS

FIG. 1 is an oil droplet size distribution chart of the emulsion.

FIG. 2 is a chart showing the changes in permeation flux of the membranes and COD levels in permeate over a prolonged 70 hour ultrafiltration run.

### DETAILED DESCRIPTION OF PREFERRED EMBODIMENTS

Cellulose acetate was chosen as the membrane material because of its high hydrophilicity (i.e. having an affinity for water) which favors the reduction of fouling tendencies of the resulting membranes. Its unique characteristics are known to be suitable for the production of membranes with high water permeability for the treatment of oily wastewater.

Commercially available cellulose acetate was used as the present membrane material. An organic solvent was selected to dissolve the cellulose acetate. In addition, non-solvent additives which are also known as modification agents are also required. Together these components form the doping solution.

A tube-in-orifice spinneret is used to form the hollow fibers via the phase inversion technique or sometimes referred to as immersion precipitation. In this method, an external coagulant or a precipitation bath and an internal coagulant or bore liquid are required to form the hollow fibers.

In a preferred embodiment, the doping solution contains 15-25 wt. % of cellulose acetate polymer, 60-81 wt. % of organic solvent and 4-15 wt. % of non-solvent additives or modification agents. The organic solvent is N-methyl-2-pyrollidone (NMP). The non-solvent additives or modification agents comprise of polyvinylpyrrolidone(PVP), inorganic or organic acids, inorganic salts or mixtures of all or some of the mentioned compounds. The external coagulant or precipitation bath used is simply fresh water. The internal coagulant or bore liquid used is either water or a mixture of water and NMP, where the mixture has a NMP composition of 20-80 wt. % in water. Other well known organic solvents that may be used are: dimethylacetamide, acetone, dimethylsulfoxide, dimethylformamide and dioxan.

The required amount of solvent and cellulose acetate polymer were placed in a reaction flask. A stirrer was set at a speed of about 500 rpm so as to ensure that all the cellulose acetate polymer pellets were dissolved. The non-solvent additives or modification agents were then introduced into the flask. Stirring is continued until all the cellulose acetate pellets and additives were completely dissolved. To remove any gas bubbles in the doping solution, it was vacuum degassed at room temperature.

The spinning solution was further allowed to stand in a stainless steel tank for twelve hours to ensure proper degassing prior to spinning. The hollow fibers were formed via phase inversion technique using a tube-in-orifice spinneret. The doping solution was extruded at a controlled rate of about 3.0 to 5.0 ml/min while the internal coagulants or bore liquid was introduced at a similar rate forming a contiguous interior cavity of the hollow fiber. The extruded hollow fibers were then passed into an external coagulant or precipitation bath of fresh water to complete the solidification process. The extruded hollow fibers may be exposed to air for a gap of between 0-50 cm from the spinneret before reaching the precipitation bath. Any residual solvents and non-solvent additives in the solidified hollow fibers were removed by fresh water leaching in a storage tank for at least 48 hours prior to use. Furthermore, the hollow fibers are stored in fresh water to prevent drying up of the hollow fibers which would lead to the collapse of the membrane pores.

It is important to note that the entire process of preparation of the hollow fibers was done at a temperature of between 10° C. to 30° C.

Experimental/Preliminary Studies

The resulting cellulose acetate hollow fiber membranes exhibit a MWCO of about 5,000 to 30,000 daltons and a pure water permeability of 100 to 300 Um².h.bar. The physical attributes of the hollow fibers are: an internal diameter of about 1,000 to 1,500 microns and a wall thickness of about 200 to 500 microns.

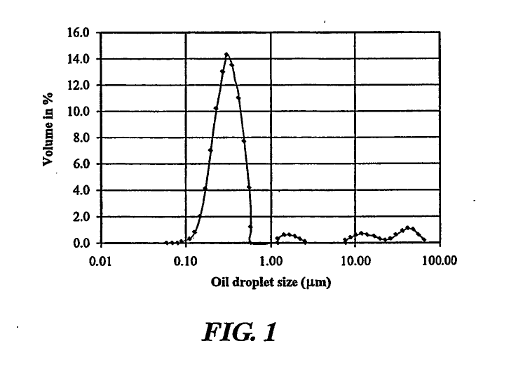

A cross-flow ultrafiltration unit was setup for tests at room temperature. It was fitted with an ultrafiltration cellulose acetate hollow fiber membrane module with a filtration area of 0.005 m². The feed liquid pumped into the membrane module was a waste lubricant fluid from a precious metal fine extrusion process. The emulsion of this waste lubricant fluid contains oil content of about 10%. The oil droplet size distribution is shown in FIG. 1. and is observed that the oil droplets in the emulsion are extremely small and are mainly under 1 micron.

The waste lubricant fluid was first filtered using a simple media filter to remove large solid contaminant particles. Prior to the ultrafiltration, the waste lubricant fluid COD was measured and found to be about 13,000 mg/L. During the ultrafiltration, trans-membrane pressure or the feed pump pressure was kept at one bar and a cross flow velocity of 1.0 m/s was maintained. The permeate (product water) which flowed into either the lumen of the hollow fibers or the shell of the module was collected and analyzed. Samples of retentate(oil) were also collected and analyzed for their COD content. After ultrafiltration, the COD of the permeate(product water) was found to be about 280 mg/L. This is a reduction of more than 95% in COD levels and the COD level was much lower than the generally accepted standards for water disposal which is 600 mg/L.

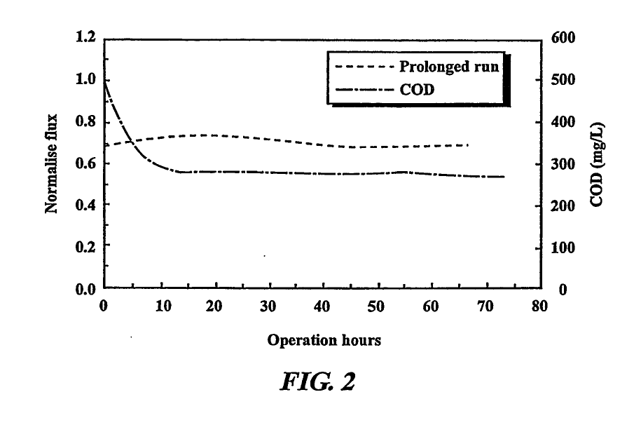

A sustained 70 hour ultrafiltration run was performed using the same setup to determine the fouling characteristics of the hollow fiber membrane by oil. In FIG. 2, no appreciable change in the permeation flux of the membrane was observed in a prolonged operation of the same cross-flow ultrafiltration unit in a 70 hour run. This indicates that no appreciable fouling of the membrane had occurred and therefore no stoppage for maintenance was required.

1. A hollow fiber membrane made of a cellulose ester for the separation of oil from water, the membrane exhibiting a Molecular Weight Cut-Off (MWCO) of about 5,000 to 30,000, a COD removal of above 95 percent and a low oil fouling tendency.

2. A hollow fiber membrane according to claim 1 wherein the membrane has a pure water permeability of about 100 to 300 L/m².h.bar.

3. A hollow fiber membrane according to claim 1 wherein the membrane has a wall thickness of 200 to 500 microns.

4. A hollow fiber membrane according to claim 1 wherein the cellulose ester is cellulose acetate.

5. A process for making cellulose based hollow fibers for the separation of oil from water which comprises the steps of:
a. forming a doping solution of about 15-25 weight percent cellulose acetate polymer, about 60-81 weight percent of organic solvent and about 4-15 weight percent non-solvent additive or additives;
b. spinning the hollow fibers via the phase inversion technique using a tube in orifice spinneret; and
c. leaching hollow fibers of solvent and non-solvent additive(s) by immersing in a water bath.

6. A process according to claim 5 wherein the making of the cellulose based hollow fibers is performed at a temperature of 10° C. to 30° C.

7. A process according to claim 5 wherein said organic solvent comprises: N-methyl-2-pyrrolidone, dimethylacetamide, acetone, dimethylsulfoxide, dimethylformamide and dioxan.

8. A process according to claim 5 wherein said non-solvent additives comprises of: polyvinylpyrrolidone, or inorganic acids, or organic acids, or inorganic salts or a mixture of all or some of the mentioned compounds.

9. A process according to claim 5 wherein said step of spinning the hollow fibers via the phase inversion technique using a tube in orifice spinneret further utilizes an external coagulant of water and an internal coagulant of water or a mixture of water and NMP, where the mixture has a NMP composition of 20-80 wt. % in water.

10. A process according to claim 9 wherein said step of spinning the hollow fibers via the phase inversion technique using a tube in orifice spinneret further exposes the hollow fiber to an air gap of 0-50 cm before it reaches the external coagulant.

11. A doping solution for spinning of cellulose acetate hollow fiber membranes for the separation of oil from water comprising of: 15-25 weight percent of cellulose acetate polymer, 60-81 weight percent of organic solvent and 4-15 weight percent of non-solvent additive or additives.

12. A doping solution according to claim 11 wherein said non-solvent additive or additives comprises of: polyvinylpyrrolidone, or inorganic acids, or organic acids, or inorganic salts or a mixture of all or some of the mentioned compounds.

13. A doping solution according to claim 11 wherein said doping solution is prepared at temperature of 10-30° C.
